(19) United States
(12) Patent Application Publication
(10) Pub. No.: US 2008/0099424 A1
(43) Pub. Date: May 1, 2008

(54) Apparatus and methods for carrying a bottle

(76) Inventors: Adam Chalekian, Racine, WI (US); Aaron Chalekian, Minneapolis, MN (US)

Correspondence Address: CYR & ASSOCIATES, P.A., 605 U.S. Highway 169, Suite 300, Plymouth, MN, 55441, US

(21) Appl. No.: 11/732,651

(22) Filed: Apr. 4, 2007

Related U.S. Application Data
(60) Provisional application No. 60/855,044, filed on Oct. 30, 2006.

(51) Int. Cl. B65D 23/10; B67B 1/00

(52) U.S. Cl. 215/396; 49/506

(57) ABSTRACT

The present invention relates to apparatus and associated methods for carrying and manipulation of bottles. The apparatus may include a closure that may be sealably secured to a bottle. The apparatus may further include a movable handle attached to the closure. The movable handle may be positionable between at least a first position and a second position. The methods may include providing a closure and a movable handle, attaching the movable handle to the closure, and positioning the movable handle in at least the first position and the second position.

### CROSS-REFERENCE TO RELATED APPLICATIONS

The present application claims the benefit and priority of U.S. provisional patent application 60/855,044 filed Oct. 30, 2006, the disclosure of which is hereby incorporated by reference in its entirety.

### BACKGROUND OF THE INVENTION

1. Field of the Invention

The present inventions relate to apparatus that allow for sealing, carrying, and manipulation of the bottle.

2. Description of the Related Art

Users frequently carry bottles of various beverages including sports drink, waters, and soft drinks about, for example, while engaging in various athletic and outdoor activities. The user may carry the bottle by hand, which may interfere with the activity because the user must set the bottle down in order to engage in certain activities and must keep track of the bottle. In addition, bottles can be unwieldy. Some beverage bottles may contain around two liters of liquid, and it may be difficult to manipulate the bottle, for example, to withdraw the liquid from the bottle by pouring. It may be desirable to carry bottles having a variety of other contents about, as well. These bottles may also be unwieldy making the bottles difficult to manipulate. Therefore, a need exists for apparatus and methods that may assist a user in carrying and manipulating bottles.

### SUMMARY OF THE INVENTIONS

Apparatus and methods in accordance with the present inventions may resolve many of the needs and shortcomings discussed above and will provide additional improvements and advantages that may be recognized by those skilled in the art upon review of the present disclosure.

The apparatus in accordance with the present inventions may include a closure configured to be sealingly secured to the bottle to retain contents within the bottle and a movable handle. The movable handle may be hingedly attached to the closure to be positionable between at least a first position and a second position.

Methods in accordance with the present inventions may include providing a closure and providing a movable handle positionable between at least a first position and a second position. The methods may further include attaching the movable handle to the closure. In various aspects, the methods may include securing the closure to a bottle, positioning the movable handle in the first position during distribution of the bottle, positioning the movable handle in the second position, and carrying the bottle by the movable handle in the second position.

Other features and advantages of the invention will become apparent from the following detailed description, and from the claims.

### BRIEF DESCRIPTION OF THE DRAWINGS

FIG. 1A illustrates a perspective view of an exemplary embodiment of an apparatus in accordance with aspects of the present inventions;

FIG. 1B illustrates another perspective view of an exemplary embodiment of an apparatus in accordance with aspects of the present inventions;

FIG. 1C illustrates another perspective view of an exemplary embodiment of an apparatus in accordance with aspects of the present inventions;

FIG. 1D illustrates another perspective view of an exemplary embodiment of an apparatus in accordance with aspects of the present inventions;

FIG. 2A illustrates a perspective view of an exemplary embodiment of an apparatus in accordance with aspects of the present inventions;

FIG. 2B illustrates a perspective view of another exemplary embodiment of an apparatus in accordance with aspects of the present inventions;

FIG. 2C illustrates in cross-section a portion of the exemplary embodiment of the apparatus according to the present inventions illustrated in FIG. 2B;

FIG. 2D illustrates in cross-section a portion of the exemplary embodiment of the apparatus according to the present inventions illustrated in FIG. 2A;

FIG. 3 illustrates a perspective view of an exemplary embodiment of an apparatus in accordance with aspects of the present inventions;

FIG. 4A illustrates a perspective view of an exemplary embodiment of portions of an apparatus in accordance with aspects of the present inventions;

FIG. 4B illustrates a perspective view of a second exemplary embodiment of portions of an apparatus in accordance with aspects of the present inventions;

FIG. 4C illustrates a perspective view of a third exemplary embodiment of portions of an apparatus in accordance with aspects of the present inventions;

FIG. 4D illustrates a perspective view of a fourth exemplary embodiment of portions of an apparatus in accordance with aspects of the present inventions;

FIG. 4E illustrates a perspective view of a fifth exemplary embodiment of portions of an apparatus in accordance with aspects of the present inventions;

FIG. 5A illustrates a perspective view of an exemplary embodiment of an apparatus in accordance with aspects of the present inventions;

FIG. 5B illustrates another perspective view of an exemplary embodiment of an apparatus in accordance with aspects of the present inventions;

FIG. 6A illustrates a perspective view of an exemplary embodiment of an apparatus in accordance with aspects of the present inventions; and,

FIG. 6B illustrates another perspective view of an exemplary embodiment of an apparatus in accordance with aspects of the present inventions;

All Figures are illustrated for ease of explanation of the basic teachings of the present invention only. The extensions of the Figures with respect to number, position, relationship and dimensions of the parts to form the preferred embodiment will be explained or will be within the skill of the art after the following description has been read and understood. Further, the exact dimensions and dimensional proportions to conform to specific force, weight, strength, and similar requirements for various applications will likewise be within the skill of the art after the following description has been read and understood.

Where used in various Figures of the drawings, the same numerals designate the same or similar parts. Furthermore, when the terms “upper,” “lower,” “right,” “left,” “forward,” “rear,” “first,” “second,” “inside,” “outside,” “front,” “back,” and similar terms are used, the terms should be understood to reference only the structure shown in the drawings and utilized only to facilitate describing the illustrated embodiments.

### DETAILED DESCRIPTION OF THE INVENTIONS

The present inventions provide an apparatus 10 and associated methods for sealing, carrying, and manipulation of bottles 200. The apparatus 10 may include a closure 20 that may be secured to the bottle 200 to seal the bottle 200 in order to secure the contents within the bottle 200. The apparatus 10 may further include a movable handle 70 secured to the closure 20. The movable handle 70 may be positionable between at least a first position 94 and a second position 96. When the apparatus 10 is secured to the bottle 200 and the movable handle 70 is positioned in the first position 94, the movable handle 70 may be generally oriented proximate the bottle 200, and may, in some aspects, be biased against portions of the outer bottle surface 210 to minimize interference with distribution through normal commercial channels. In the second position 96, the movable handle 70 may extend generally outward from the bottle 200, for example, to allow the user to apprehend the bottle 200 by the movable handle 70 to carry the bottle 200 and to manipulate the bottle 200 including pouring, handling, and passing the bottle 200 about.

The Figures generally illustrate exemplary embodiments of the apparatus 10 in accordance with aspects of the present inventions. The particularly illustrated embodiments of the apparatus 10 have been chosen for ease of explanation and understanding of various aspects of the present inventions. These illustrated embodiments are not meant to limit the scope of coverage but, instead, to assist in understanding the context of the language used in this specification and in the appended claims. Accordingly, the appended claims may encompass variations of the present inventions that differ from the illustrated embodiments.

The apparatus 10 in accordance with the present inventions includes the closure 20 securable to the bottle 200 to secure the contents within the bottle 200. The apparatus 10 according to the present inventions further includes the movable handle 70 which is positionable between at least a first position 94 and a second position 96 and is attached to the closure 20. The closure 20 and the movable handle 70 may be made of molded plastics or other materials and combinations of materials and made by various manufacturing processes, as would be readily recognized by those skilled in the art upon review of this disclosure.

The bottle 200 defines and outer bottle surface 210, an inner bottle surface 220. The bottle 200 may define a chamber 230 that may contain the contents such as a liquid, a powder, or other bulk materials, and the bottle 200 may define at least one aperture 250 through which the contents may be received into the chamber 230 and withdrawn from the chamber 230. The bottle 200 typically includes a bottleneck 240, which is a portion of the bottle 200 that generally defines the aperture 250. The bottleneck 240 may be configured with a detent 260 such as threads or a lip to engage at least portions of a closure 20 to sealingly secure the closure 20 over the aperture 250 in order to retain the contents within the chamber 230. The bottle 200 may be of various shapes and sizes and may be made of glass, various plastics, and other materials and combinations of materials as would be recognized by those skilled in the art upon review of this disclosure.

The closure 20 may be configured to be removably secured over the aperture 250 to seal the aperture 250 in order to retain the contents within the chamber 230 of the bottle. In various aspects, the closure 20 may be configured to engage various detents 260 on the bottleneck 240. In various aspects, the closure 20 may be configured to threadably engage the detent 260 on the bottleneck 240 or to snappably engage the detent 260 on the bottleneck 240. In various aspects, the closure 20 may include a cap 30 that defines at least an upper surface 32 and a peripheral surface 34. The portion of the cap 30 that defines the upper surface 32 typically occludes the aperture 250 when the cap 30 is secured to the bottle 200. The portion of the cap 30 that defines the peripheral surface 34 typically is configured to surround portions of the bottleneck 240 and to be secured to the detent 260 so that the cap 30 may be sealingly secured to the bottle 200. In various aspects the cap 30 may be configured to threadably engage the detent 260 on the bottleneck 240 or to snappably engage the detent 260 on the bottleneck 240 to occlude the aperture 250. In some aspects, the closure 20 may be configured to be removable so that the closure 20 may be disengaged from the bottleneck 240 to allow the contents to be withdrawn from the chamber 230, while in other aspects, the closure 20 may be configured to be generally secured to the bottleneck 240 with the closure 20 including other features to allow the contents to be withdrawn from the bottle 200. At least a portion of the peripheral surface 34, in various aspects, may be configured as gripping surface 105 to allow user to apprehend the cap 30 in order to disengage the cap 30 from the detent 260.

The closure 20 may, in some aspects, include a base ring 40, with the base ring 40 secured about the bottleneck 240. Typically, portions of the cap 30 are engaged with portions of the base ring 40 along a frangible breakline 103, so that the cap 30 may be disengaged from the base ring 40 along the frangible breakline 103. The base ring 40 may help secure the cap 30 to the bottle 200 to occlude the aperture 250. The fangible breakline is typically broken by removal of the cap 30 from the bottle 200, which may provide indications that the bottle 200 has been opened or other tampering.

In various aspects, the closure 20 may include a nipple structure 50 configured into the cap 30. The nipple structure 50 typically includes a nipple 52 moveable between a first nipple position 54 and a second nipple position 56. With the cap 30 secured to the bottle 200 and the nipple 52 in the first nipple position 54, the contents are generally secured within the chamber 230. When the nipple 52 is placed in the second nipple position 56, the contents may be withdrawn through one or more ports 69 defined by the nipple structure 50. The nipple structure 50 is typically configured into a portion of the upper surface 32 of the cap 30.

In various aspects, the closure 20 may include a flip top 62 configured into the cap 30 that allows the contents to be retained within the chamber 230 or withdrawn from the chamber 230. The flip top 62 may, in some aspects, be hingedly secured to portions of the closure 20 by a flip top hinge 67 and movable between a first top position 64 and a second position 66. In the first position 64, portions of the flip top 62 may securably engage other portions of the closure to occlude one or more ports 69 in order to secure the contents within the chamber 230 of the bottle 200. The portions of the flip top 62 may be disengaged from portions of the closure 20 so that the flip top 62 may be positioned in the second top position 66. In the second top position 66, the one or more ports 69 are revealed, so that the contents may be withdrawn through the one or more ports 69. The flip top 62, in other aspects, may be configured to removably engage structures on portions of the closure 20 so that one or more ports 69 are occluded when the flip top 62 is engaged and one or more ports 69 are revealed when the flip top 62 is disengaged.

In various other aspects, the closure 20 may be configured with combinations of caps 30 and base rings 40. The closure 20 may include nipple structures 50, flip tops 62, and other structures to allow removal of the contents. The closure 20 may be configured to engage various detents 260 on the bottle 200. The closure 20 may be configured with various combinations of structures to engage the bottle 200 and to allow withdrawal of the contents. The closure 20 may be configured in other ways and combinations of ways as would be recognized by those skilled in the art upon review of this disclosure.

The movable handle 70 may be attached to the closure 20 to aid the user in carrying and manipulating the bottle 200. The movable handle defines a first end 71 and a second end 73. The first end 71 of the movable handle may be attached to the closure 20. In some aspects, the movable handle 70 may be attached to the peripheral surface 34 of the cap 30. In other aspects, the movable handle 70 may be attached to the base ring 40.

When attached to the closure 20, the movable handle 70 is configured to be positionable between at least a first position 94 and a second position 96. The movable handle 70 may be configured to be generally positioned proximate the bottle surface 210 of the bottle 200 in the first position 94 in order to minimize interference. In some aspects, the movable handle 70 may be configured to include curved portions 76 that conform to the shape of the outer bottle surface 210 when the moveable handle is positioned in the first position 94 in order to allow the bottle 200 to minimize interference in order to allow, for example, the bottle 200 to be aggregated with other bottles 200 for distribution, shipped, placed on retail shelving, stowed, and stored. In some aspects, the movable handle 70 may be biased against portions of the outer bottle surface 210 when the closure 20 is secured to the bottle 200 and the movable handle 70 is positioned in the first position 94 in order to prevent the movable handle from interfering with distribution through normal commercial channels. The movable handle 70 may be otherwise configured to conform to the bottle 200 in the first position 94 in order to facilitate, for example, distribution, aggregation, stowage, or storage of the bottle 200. Attachment of the movable handle 70 to the peripheral surface 34 or to the base ring 40 may allow the movable handle 70 to be biased against the outer bottle surface 210 and otherwise positioned about the outer bottle surface 210 to minimize interference.

The movable handle 70 may extend generally outward from the bottle 200 when the closure 20 is secured to the bottle 200 and the movable handle 70 is positioned in the second position 96 to allow the user to apprehend the bottle 200 by the movable handle 70 in order to carry the bottle 200 and to manipulate the bottle 200 including pouring, handling, and passing the bottle 200 about. In various aspects, the movable handle 70 may define, typically generally proximate the second end 73, one or more loops 72 through which, inter alia, the user's fingers, the user's hand, a strap, a clip 74 may be inserted to secure the bottle 200, to carry the bottle 200, or to manipulate the bottle 200. At least portions of the movable handle 70 may be configured with a gripping surface 105, typically generally proximate the second end 73, to aid the user in grasping the movable handle 70. In various aspects, the movable handle 70 may be configured to include the clip 74 including clasps and various fasteners that may allow the movable handle 70 to be secured about a person such as to a backpack or to a belt loop. In various aspects the movable handle 70 may include a flared portion 75, which may aid the user in gripping the movable handle 70. The movable handle 70 may also include straight portions 77 in some aspects.

In various aspects, the movable handle 70 generally proximate the first end 71 may be attached to the closure 20, at least in part, by a hinge 98. In various aspects, the hinge 98 may be a living hinge 101, which may allow for efficient manufacture of the closure 20 with attached movable handle 70. In various aspects, the hinge 98 may be a pinned hinge 107, a pivot hinge, a butterfly hinge, or other hinge or combination of hinges or similar features that allow the movable handle 70 to be positioned between at least a first position 94 and a second position 96 as would be recognized by those skilled in the art upon review of this disclosure. The movable handle 70 and the closure 20 may be configured in various aspects such that the movable handle 70 may be indexed into at least the first position 94 and the second position 96.

In operation, the closure 20 portion of the apparatus 10 according to the present inventions may be sealingly secured to the detent 260 on the bottleneck 240 in order to generally retain the contents within the bottle 200. The movable handle 70 may be positioned in the first position 94 so that the bottle 200 may be aggregated with other bottles 200 to minimize interference by the movable handle 70 with distribution. The user may then position the movable handle 70 in the second position 96 in order to use the movable handle 70 to carry or manipulate the bottle 200. For example, in some aspects the user may insert one or more fingers through the loop 72 defined by the movable handle 70 in order to carry the bottle 200. As another example, the user may secure the loop 72 defined by the movable handle 70 to the clip 74 that is, in turn, attached to a belt loop or to a backpack in order to carry the bottle 200. As a further example, in various aspects, the user may manipulate at least the bottleneck 240 portion of the bottle 200 by the movable handle 70 in order to manipulate the bottle 200 during withdraw of at least portions of the contents.

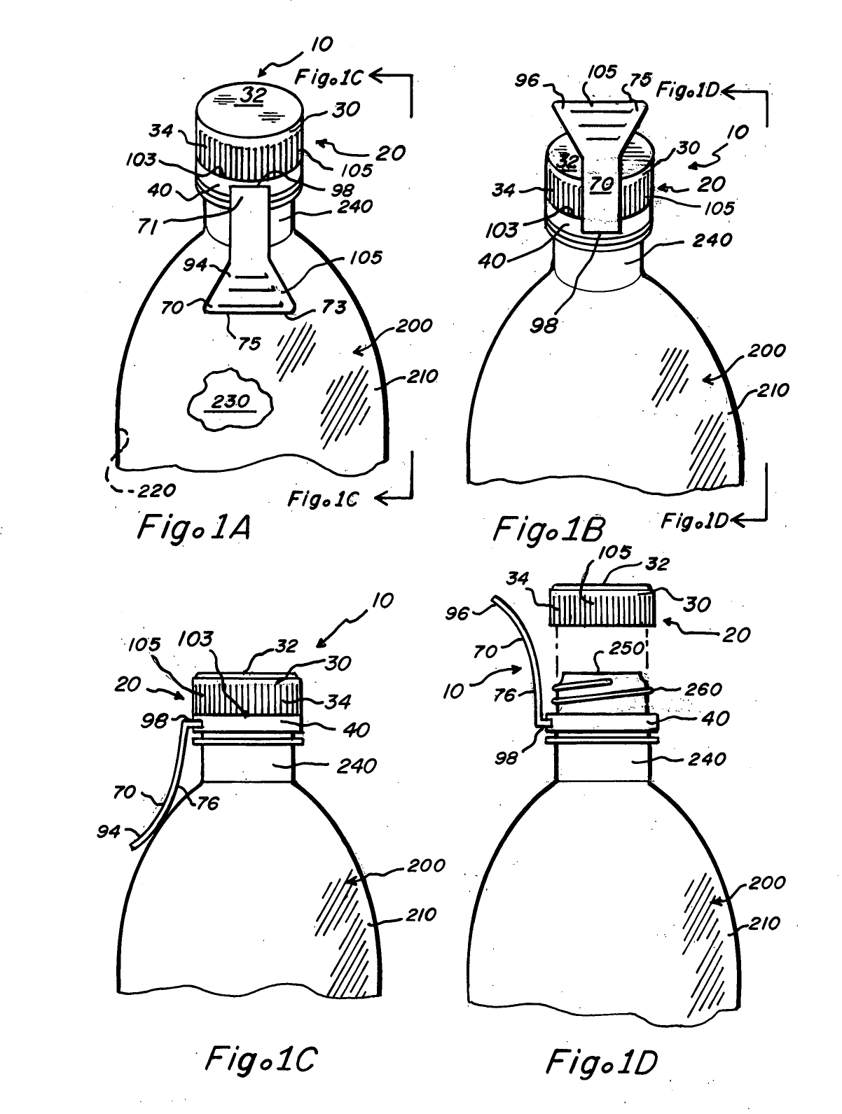

Specific embodiments of the apparatus 10 according to the present inventions are illustrated in the Figures. FIGS. 1A to 1D illustrate the apparatus 10 according to the present invention including the closure 20 and the movable handle 70 in conjunction with the bottle 200. In FIG. 1A, the closure 20 is secured to the bottleneck 240. The closure 20 in this embodiment includes the cap 30 and the base ring 40. The cap 30 may be secured to the base ring 40 along a frangible breakline 103, as illustrated. The cap 30 may be twisted, in this embodiment, to separate the cap 30 from the base ring 40 along the frangible breakline 103, and the cap 30 may then be removed so that the contents may be withdrawn from the bottle 200.

In the embodiment of FIG. 1A, the first end 71 of the movable handle 70 is attached to the base ring 40 by the hinge 98, and the movable handle 70 is illustrated as positioned in the first position 94. The movable handle 70 includes the flared portion 75 generally proximate the second end 73. The flared portion 75 in this embodiment is configured with the gripping surface 105 in order to aid the user in apprehending the movable handle 70. Because the movable handle 70 is secured to the Base ring 40 in this embodiment, the movable handle 70 remains attached to the bottle 200 when the cap 30 portion of the closure 20 has been removed from the bottleneck 240. Accordingly, after removal of the cap 30 portion of the closure 20, the user may use the movable handle 70 to manipulate the bottle 200, for example, in order to withdraw at least a portion of the contents from the bottle 200 by pouring.

FIG. 1B illustrates the movable handle 70 positioned in the second position 96. The movable handle 70 is attached to the base ring 40 by hinge 98, in this embodiment, to allow the movable handle 70 to be positioned in at least a first position 94 and a second position 96. The movable handle 70 may be variously configured to facilitate apprehending by the user such as the flared portion 75 with gripping surface 105 in this illustrated embodiment.

In the embodiment illustrated in FIG. 1C, the movable handle 70 is positioned in the first position 94. The movable handle 70 may be configured to lie proximate the outer bottle surface 210 of the bottle 200 particularly proximate the bottleneck 240 by, for example, including the curved portion 76, as illustrated. Attachment of the movable handle 70 to the base ring 40 may facilitate positioning the movable handle 70 proximate the outer bottle surface 210 in the first position 94. This may minimize interference by the movable handle 70 in order to facilitate commercial distribution of bottles 200 to which apparatus 10 according to the present invention is secured. Configuring the movable handle 70 with various curvatures may also aid the user in apprehending the movable handle 70, and may aid in carrying and manipulating the bottle 200.

In FIG. 1D, the cap 30 portion of the closure 20 has been removed while the base ring 40 portion of the closure 20 remains secured about the bottleneck 240. The cap 30, in this embodiment, has been configured to be removably secured to the detent 260 configured as a set of threads on the bottle 200 neck. With the cap 30 removed, contents may be withdrawn from the bottle 200 through the aperture 250. The movable handle 70 is attached to the base ring 40 by the hinge 98, and the movable handle 70 is positioned in the second position 96, as illustrated. The user may grasp the bottle 200, at least in part, by the movable handle 70 in order to manipulate the bottle 200 while, for example, withdrawing the contents through the aperture 250 by pouring.

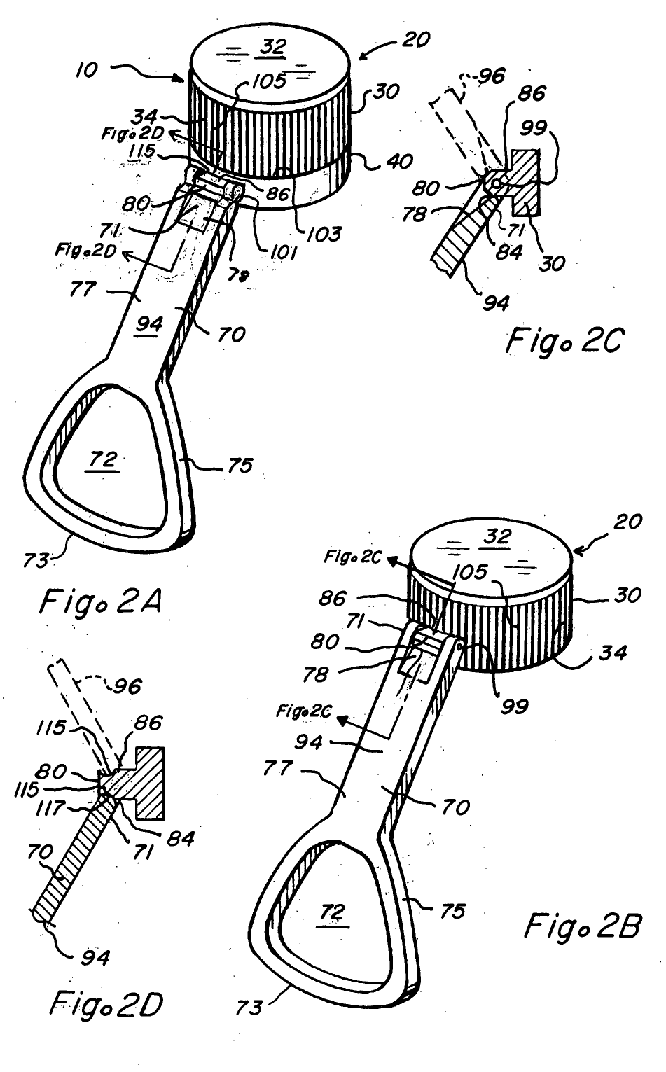

An embodiment of the apparatus 10 according to the present inventions is illustrated in FIG. 2A including the closure 20 and the movable handle 70. In this embodiment, the closure 20 includes the cap 30 and the base ring 40. The first end 71 of the movable handle 70 is attached to the base ring 40 by the hinge 98 configured as a living hinge 101. The movable handle 70, in this embodiment, is configured to define the loop 72 through which, for example, a finger, a strap, or a hook could pass to grasp or to secure the movable handle 70, and, hence, the bottle 200.

As illustrated in FIG. 2A, the movable handle 70 is positioned in the first position 94. The movable handle 70, as illustrated, includes a stop 78 that engages stop block 80, which is included on the base ring 40, so that the position of the movable handle 70 may be indexed. In order to index the position of the movable handle 70, the stop block 80 defines a first click point 84 and a second click point 86. When the stop 78 engages the stop block 80 at the first click point 84, the movable handle 70 is generally located in the first position 94 to be generally secured in the first position 94. The stop 78 may be disengaged from the first click point 84 and engaged with the stop block 80 at the second click point 86 so that the movable handle 70 is generally located in the second position 96 to be generally secured in the second position 96. The movable handle 70 could be indexed so that the movable handle 70 may be located in a plurality of positions in various embodiments by including a plurality of stop blocks 80 to define a plurality of click points. The movable handle 70 could then be indexed among the plurality of click points defined by the plurality of stop blocks 80. The movable handle 70 could be indexed in other ways as would be recognized by those skilled in the art upon review of this disclosure.

Another embodiment of the apparatus 10 according to the present inventions is illustrated in FIG. 2B, including the closure 20, which includes the cap 30, and the movable handle 70. The movable handle 70, in this embodiment, is configured to define the loop 72 through which, for example, a finger, a strap, or a hook could pass to grasp or to secure the movable handle 70.

The movable handle 70 may be attached to the peripheral surface 34 defined by the cap 30 by the hinge 98 configured as a pinned hinge 107 rotatable about hinge pins 99, as illustrated in FIG. 2B. The movable handle 70 is illustrated in the first position 94. The movable handle 70, as illustrated, includes a stop 78 that engages stop block 80, which is included on the peripheral surface 34 of cap 30, so that the position of the movable handle 70 may be indexed. The stop block 80 defines a first click point 84 and a second click point 86. When the stop 78 engages the stop block 80 at the first click point 84, the movable handle 70 is generally located in the first position 94 to be generally secured in the first position 94. The stop 78 may be disengaged from the first click point 84 and engaged with the stop block 80 at the second click point 86 so that the movable handle 70 is generally located in the second position 96 to be generally secured in the second position 96. The movable handle 70 could be indexed between a plurality of positions in various embodiments by including a plurality of stop blocks 80 to define a plurality of click points. The movable handle 70 could then be indexed among the plurality of click points defined by the plurality of stop blocks 80.

FIG. 2C illustrated in cross-section a detail of the attachment of the movable handle 70 to the peripheral surface in the embodiment illustrated in FIG. 2B. As can be seen, the first end 71 of the movable handle 70 may engage the stop block 80 at the first click point 84 to generally locate the movable handle 70 in the first position 94. As illustrated in phantom, the first end 71 of the movable handle 70 may engage the stop block 80 at the second click point 86 to generally locate the movable handle 70 in the second position 96. In this embodiment, the first end 71 of the movable handle is generally configured with a substantially flat surface that engages the first click point 84 and the second click point 86, which are also configured with substantially flat surfaces.

FIG. 2D illustrated in cross-section a detail of the attachment of the movable handle 70 to the peripheral surface in the embodiment illustrated in FIG. 2A. As can be seen, the first end 71 of the movable handle 70 may engage the stop block 80 at the first click point 84 to generally locate the movable handle 70 in the first position 94, and may engage the stop block 80 at the second click point 86 to generally locate the movable handle 70 in the second position 96. Accordingly, the movable handle 70 may be indexed between the first position 84 and the second position 86. In this embodiment, the first click point 84 and the second click point 86 of the stop block 80 are configured as a pocket 115. The first end 71 of the movable handle 70 is configured with a bull nose 117 that corresponds to the pocket 115 so that the movable handle 70 may locate into the pocket 115 at the first click point 84 and at the second click point 86.

FIG. 3 illustrates an embodiment of the apparatus 10 according to the present invention secured to the bottleneck 240 of the bottle 200. In this embodiment, the closure 20 apparatus 10 includes the cap 30. The first end 71 of the movable handle 70 is attached to the cap 30 along the peripheral surface 34 by the hinge 98, so that the movable handle 70 may be positioned in at least a first position 94 and a second position 96. As illustrated, the movable handle 70 is positioned in the first position 94. The movable handle 70, in this embodiment, defines the loop 72 generally proximate the second end 73 through which, for example, a finger, a strap, or a hook could pass to grasp or to secure the movable handle 70.

The movable handle 70 may be configured to be generally biased against the outer bottle surface 210 of the bottle 200 particularly proximate the bottleneck 240 by, for example, including the curved portion 76, as illustrated in FIG. 3. Attachment of the movable handle 70 to the peripheral surface 34 defined by the cap 30 may allow the movable handle to be biased against the outer bottle surface 210. This may minimize the space required by the movable handle 70 in order to facilitate commercial distribution of bottles 200 to which apparatus 10 according to the present invention is secured.

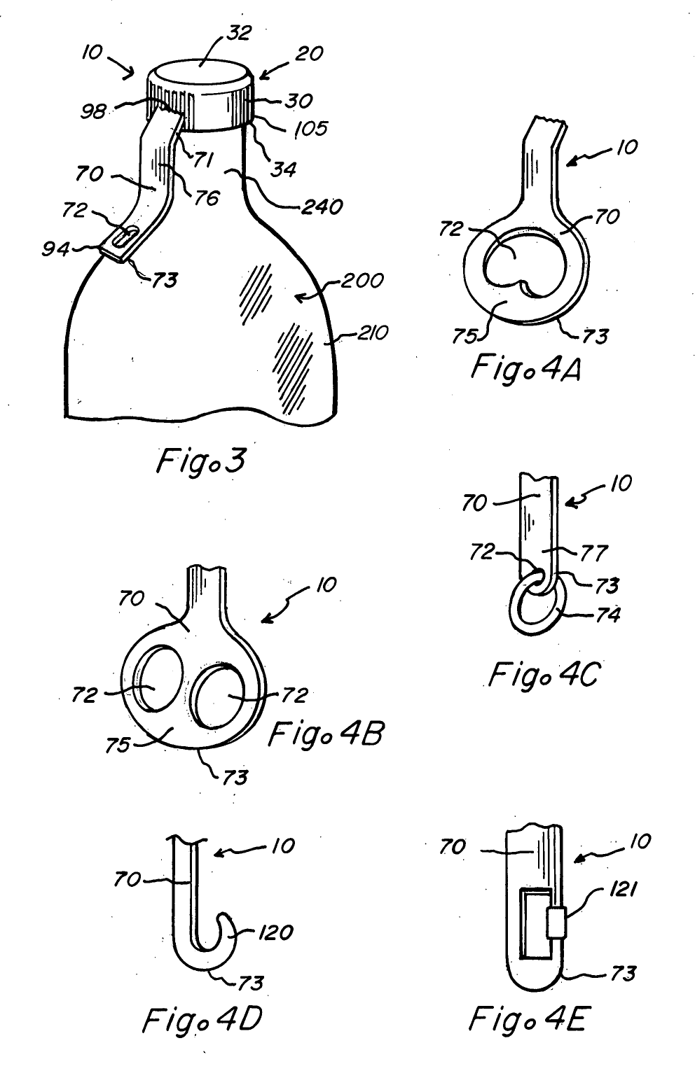

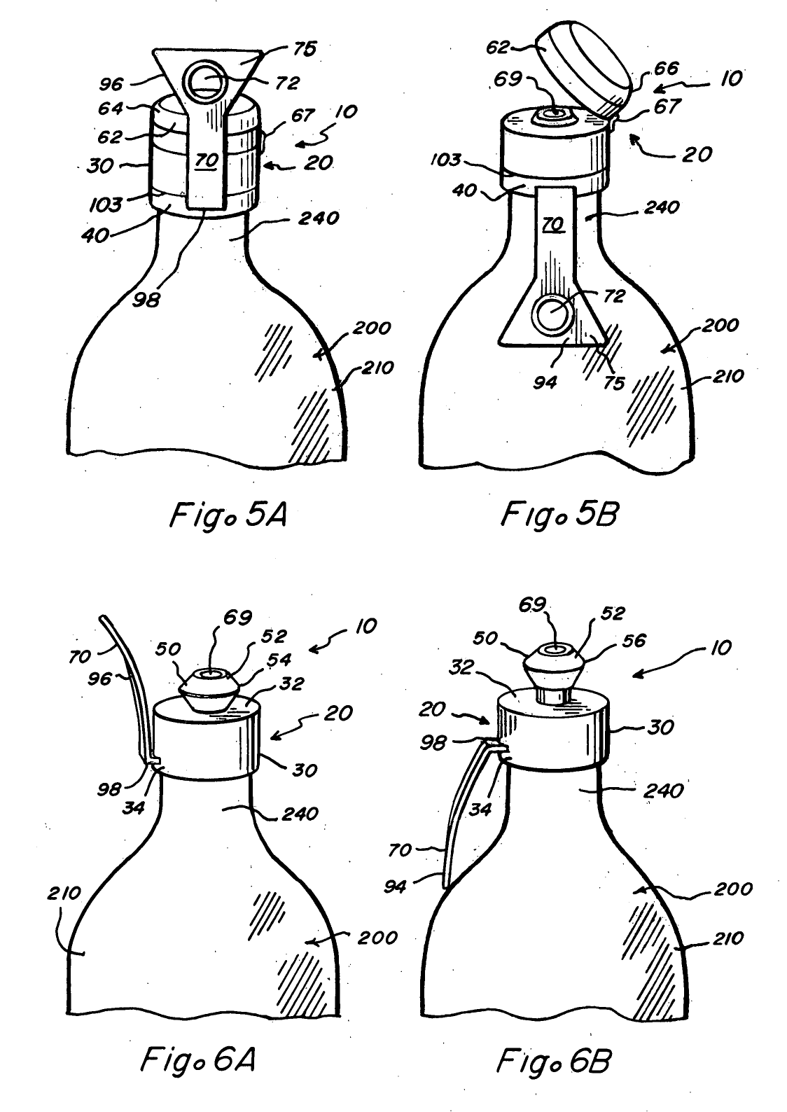

FIGS. 4A, 4B, 4C, 4D, and 4E illustrate embodiments of portions of the movable handle 70 of an apparatus 10 according to the present inventions. In FIG. 4A, the loop 72 defined by the movable handle 70 generally proximate the second end 73 includes curves that could accommodate two fingers in the flared portion 75. The movable handle 70 in FIG. 4B includes the flared portion 75 generally proximate the second end 73 that defines two loops 72 that could accommodate two fingers. In various embodiments, the movable handle 70 could define a plurality of loops 72 to, for example, accommodate a plurality of fingers. In FIG. 4C, the movable handle 70 includes a straight portion 77. The movable handle 70, as illustrated in FIG. 4C, defines the loop 72 and the clip 74 is passed through the loop 72 generally proximate the second end 73. FIG. 4D illustrates an embodiment of the movable handle 70 generally configured as a hook 120 proximate the second end 73. In FIG. 4E, the movable handle is generally configured to include a carabiner 121 that may be used to secure the bottle. Other embodiments of the movable handle 70 that would aid in grasping the movable handle 70 or otherwise attaching the movable handle 70 would readily be recognized by those skilled in the art upon review of this disclosure.

FIGS. 5A and 5B illustrate an embodiment of an apparatus 10 according to the present inventions with the closure 20 configured with a flip top 62 and secured to the neck of the bottle 200. As illustrated in FIG. 5A, the closure 20 includes the cap 30 with the flip top 62 and the base ring 40. The cap 30 may be secured to the base ring 40 along the frangible breakline 103. The movable handle 70, in this embodiment is attached by hinge 98 to the base ring 40, and the movable handle 70 is illustrated in the second position 96. The bottle 200 may then be carried by the movable handle 70 with the movable handle 70 positioned in the second position 96. The cap 30 includes the flip top 62, which may be positionable between at least a first top position 64 and a second top position 66. As illustrated in FIG. 5A, the flip top 62 is positioned in the first top position 64 to generally secure the contents within the bottle 200.

In FIG. 5B, the flip top 62 is positioned in the second top position 66, which reveals the port 69 so that the contents may be withdrawn from the bottle 200 through the port. As illustrated, the flip top 62 is secured by flip top hinge 67, although the flip top 62 may be secured in other ways those skilled in the art will recognize upon review of this disclosure. As illustrated, the movable handle 70 may be placed in the first position 94 when the flip top 62 is placed in the second top position 66 to generally prevent the movable handle 70 from interfering with the withdrawal of the contents from the bottle 200 through the port 69.

FIGS. 6A and 6B illustrate an embodiment of an apparatus 10 according to the present inventions with the closure 20 configured with the nipple structure 50 and secured to the neck of the bottle 200. As illustrated in FIG. 6A, the closure 20 includes a cap 30 with the nipple structure 50 generally configured into the upper surface 32 of the cap 30. The movable handle 70, in this embodiment is attached by hinge 98 to portions of the peripheral surface 34 of the cap 30, and the movable handle 70 is illustrated in the second position 96. The bottle 200 may then be carried by the movable handle 70 with the movable handle 70 positioned in the second position 96. The nipple structure 50 includes the nipple 52, which may be positionable between at least a first nipple position 54 and a second nipple position 56. As illustrated in FIG. 6A, the nipple 52 is positioned in the first nipple position 54 to generally secure the contents within the bottle 200.

In FIG. 6B, the nipple 52 is positioned in the second nipple position 56 to allow the contents to be withdrawn from the bottle 200 through the port 69. As illustrated, the movable handle 70 may be placed in the first position 94 so that the movable handle 70 to generally prevent the movable handle 70 from interfering with the withdrawal of the contents from the bottle 200 through the port 69.

The present inventions also provide methods for carrying and manipulation of bottles 200. The methods may include providing a closure 20 and may further include sealingly securing the closure 20 to the bottle 200 to generally secure the contents within the bottle 200. The apparatus 10 may further include providing a movable handle 70 and attaching the movable handle 70 to the closure 20. The movable handle 70 may be positionable between at least a first position 94 and a second position 96. The methods may include positioning the movable handle 70 is positioned in the first position 94 to allow the bottle 200 to be distributed through commercial channels. Positioning the movable handle 70 in the second position 96 to allow the user to apprehend the bottle 200 by the movable handle 70 to carry the bottle 200 and to manipulate the bottle 200 including pouring, handling, and passing the bottle 200 about may also be included in the methods. The methods may further include providing a clip 74 and securing the clip 74 to a loop 72 defined by the movable handle 70. The methods may also include configuring the movable handle 70 to facilitate gripping of the movable handle 70 by providing loops 72, flared portions 75 and grippable surfaces 115. The methods may also include configuring the movable handle to define a hook 120, or configuring the movable handle to include a carabiner 121.

The foregoing discussion discloses and describes merely exemplary embodiments of the present inventions. Upon review of the specification, one skilled in the art will readily recognize from such discussion, and from the accompanying figures and claims, that various changes, modifications and variations can be made therein without departing from the spirit and scope of the invention as defined in the following claims.

What is claimed is:

1. An apparatus, comprising:
a closure, the closure configured to be sealingly secured to a bottle to retain contents within the bottle;
a movable handle, the movable handle hingedly attached to the closure, the movable handle positionable between at least a first position and a second position.

2. The apparatus, as in claim 1, further comprising:
the closure includes a cap, the cap defines a peripheral surface, the movable handle hingedly attached to the peripheral surface.

3. The apparatus, as in claim 1, further comprising:
the closure comprising a cap and a base ring, the cap engaged with the base ring along a frangible breakline; and
the movable handle hingedly attached to the base ring.

4. The apparatus, as in claim 1, further comprising: the movable handle is indexably positionable between the first position and the second position.

5. The apparatus, as in claim 4, further comprising:
a stop block, the stop block secured to a portion of the closure, the stop block defining a first click point and the stop block defining a second click point;
a portion of the movable handle defining a stop, the stop configured to engage the stop block at the first click point when the movable handle is generally in the first position, and the stop configured to engage the stop block at the second click point when the movable handle is in the second position.

6. The apparatus, as in claim 1, further comprising:
the movable handle hingedly attached to the closure by a hinge configured as a living hinge.

7. The apparatus, as in claim 1, further comprising:
the movable handle hingedly attached to the closure by a hinge configured as a pinned hinge.

8. The apparatus, as in claim 1, further comprising:
the movable handle configured to define at least one loop.

9. The apparatus, as in claim 1, further comprising:
the movable handle includes a carabiner.

10. The apparatus, as in claim 1, further comprising:
the movable handle includes a clip.

11. The apparatus, as in claim 1, further comprising:
the movable handle configured to define a hook proximate a second end.

12. The apparatus, as in claim 1, further comprising:
the movable handle includes a gripping surface.

13. An apparatus, comprising:
a closure means for sealably securing contents within a bottle; and
a movable handle means for carrying the bottle, the movable handle means attached to the closure means.

14. A method, including:
providing a closure;
providing a movable handle, the movable handle positionable between at least a first position and a second position; and
attaching the movable handle to the closure.

15. The method, as in claim 14, further including:
securing the closure to a bottle;
positioning the movable handle in the first position during distribution of the bottle;
positioning the movable handle in the second position; and
carrying the bottle by the movable handle in the second position.

16. The method, as in claim 14, further including:
providing a clip; and
securing the clip to the movable handle.
